(19) United States
(12) Patent Application Publication
(10) Pub. No.: US 2015/0282444 A1
(43) Pub. Date: Oct. 8, 2015

(54) HYDROPONIC FLOOD TABLE

(71) Applicants: Gregory S. Butler, Lapeer, MI (US); William M. Willemsen, Waterford, MI (US)

(72) Inventors: Gregory S. Butler, Lapeer, MI (US); William M. Willemsen, Waterford, MI (US)

(21) Appl. No.: 14/677,249

(22) Filed: Apr. 2, 2015

Related U.S. Application Data
(60) Provisional application No. 61/975,345, filed on Apr. 4, 2014.

(51) Int. Cl. A01G 31/02; A01G 7/04

(52) U.S. Cl. CPC A01G 31/02; A01G 7/045

(57) ABSTRACT

A modular hydroponic flood table arrangement with components that are assembled to create different types of growing arrangements. The arrangement includes a flood table that is typically used as a bottom row flood table from which various frame members are attached. Various accessories are attached to the frame members including a scrog, additional rows of flood tables, lights, tent members, etc. The flood table is also configured to have an aeration channel with an aeration plate from which air bubbles may be passed through the aeration plate in order to aerate the liquid medium contained within the flood table. This helps to promote plant root growth for plants that are placed or growing within the arrangement. An additional feature of the invention includes the attachment of caster wheels to the bottom flood table so that their entire arrangement may be moved around using the wheels.

### FIELD OF THE INVENTION

The present invention relates to a modular hydroponic flood table arrangement.

### BACKGROUND OF THE INVENTION

In the field of horticulture plants are grown in a type of container containing soil or nutrient medium. The containers are placed in flood tables or trays, where the tray is flooded with water or liquid media in order to expose the plant's roots to the water or liquid media. Certain growing arrangements also sometimes include air stones placed within the trays in order to aerate the liquid media with certain gases. The flood tables are typically a flat shallow box or table made of wood or metals having a depth suitable to hold liquid. The bottom surface of the table is usually slightly angled to direct the liquid toward one or more drain openings so that the tables can be drained after the plants have been watered. The flood tables are sometimes placed in green houses so that the plants are exposed to natural light and in some circumstances artificial lights are strung above the plants to provide additional light. Growing plants in this type of environment can required a lot of space because the tables are a single level so that the plants can grow and receive light. The flood tables themselves are large, bulky and require a large area when being stored. It is therefore an object of the present invention to provide a modular flood table arrangement that will require less storage space. It is further an object of the present invention to provide a flood table arrangement that can easily be moved between locations. It is yet a further object of the invention to provide a flood table arrangement that is modular and can accommodate growing plants at different stages of maturity. It is yet a further object of the invention to provide improved aeration features that more effectively aerate the liquid media or water within the flood table.

### SUMMARY OF THE INVENTION

A modular flood table arrangement having a first row flood table with a top edge that has two or more apertures, a bottom surface and one or more walls extending between the top edge and the bottom surface, wherein the top edge forms an opening of the first row flood table and the one or more walls extending between the top edge and the bottom surface give the first row flood table depth for placing growing medium and plants or planters with growing plants into the first row flood table.

The first row flood table also includes two or more drain wells formed on the bottom surface with an inlet and an outlet formed on the bottom surface located in a respective one of the two or more drain wells. The first row flood table also has a flood channel formed on the bottom surface that holds a liquid and directs the liquid between the two or more drain wells, between the inlet and the outlet. There is also an aeration channel formed in the first flow flood table, located below the flood channel. An aeration plate extends over the aeration channel and has a pores formed through the plate that allow gas to pass through the pores, while the pores are impermeable to liquid passing through the pores. There is an aeration inlet located in the aeration channel extends through the bottom surface to an exterior surface of the first row flood table. The aeration inlet is connected to a gas source that pumps gas into the aeration channel, thereby allowing the gas to migrate through the aeration plate into the liquid in the flood channel that is located above the aeration plate.

The modular flood table arrangement also includes two or more vertical frame members each being connected to one of the two or more apertures located on the top edge of the first row flood table. Connected to the two or more vertical frame members is one or more additional accessories. Additional accessories include a tent over the first row flood table, lights, a scrog and additional rows of flood tables, where the two or more vertical frame members connect to the bottom of a second row flood table.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an angled side perspective view of a hydroponic flood table, in accordance with the invention;

FIG. 2 is an top side plan view of the hydroponic flood table in accordance with the invention;

FIG. 3 is a top or bottom plan edge view of the hydroponic flood table in accordance with the invention;

FIG. 4 is a left or right plan edge view of the hydroponic flood table in accordance with the invention;

FIG. 5 is a bottom side plan view of the hydroponic flood table in accordance with the invention;

FIG. 6 is an angled side perspective view of a hydroponic flood table, in accordance with an alternate embodiment of the invention;

FIG. 7 is an top side plan view of the hydroponic flood table in accordance with an alternate embodiment of the invention;

FIG. 8 is a top or bottom plan edge view of the hydroponic flood table in accordance with an alternate embodiment of the invention;

FIG. 9 is a left or right plan edge view of the hydroponic flood table in accordance with an alternate embodiment of the invention;

FIG. 10 is a bottom side plan view of the hydroponic flood table in accordance with an alternate embodiment of the invention;

FIG. 11 is an angled side perspective view of a modular flood table arrangement that is a flower assembly growing set up;

FIG. 12 is an angled side perspective view of a modular flood table arrangement that is a veg assembly growing set up;

FIG. 13 is an angled side perspective view of a modular flood table arrangement that is a clone assembly growing set up;

FIG. 14 is an angled side perspective view of a modular flood table arrangement that is a clone assembly growing set up with a tent attached;

FIG. 15 is a cross-sectional side view of a flood table filled with liquid and having an aeration pump and aeration plate connected;

FIG. 16 is a side plan view of an alternate embodiment of the modular flood table arrangement;

FIG. 17 is a cross sectional plan view of a portion of the veg assembly; and

FIG. 18 is a side perspective view of a flood table with an aeration pump connected.

### DETAILED DESCRIPTION OF THE INVENTION

The following description of the preferred embodiment(s) is merely exemplary in nature and is in no way intended to limit the invention, its application, or uses.

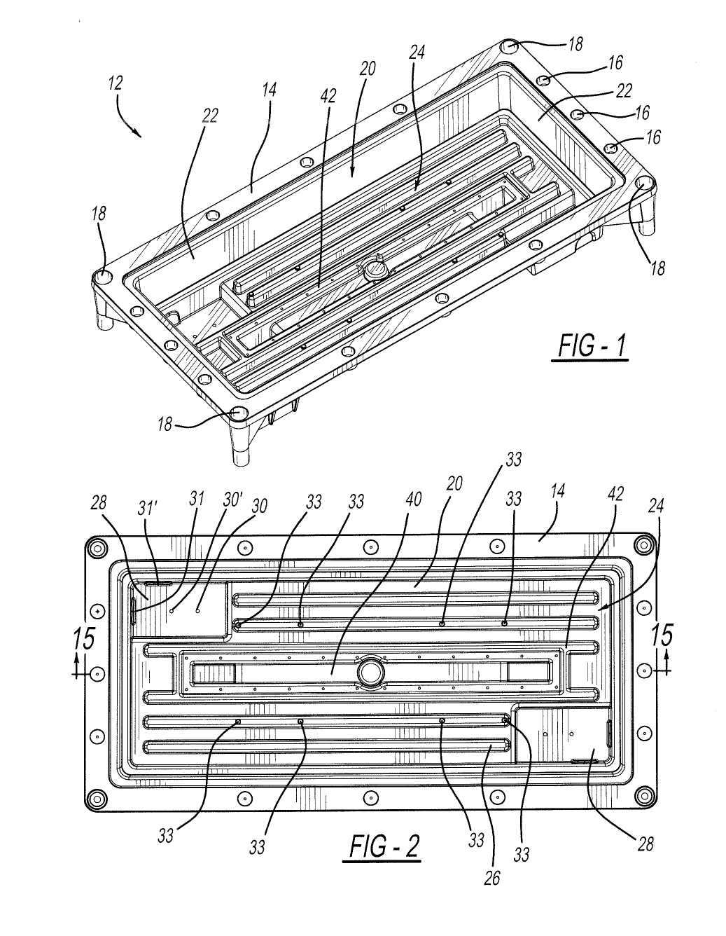

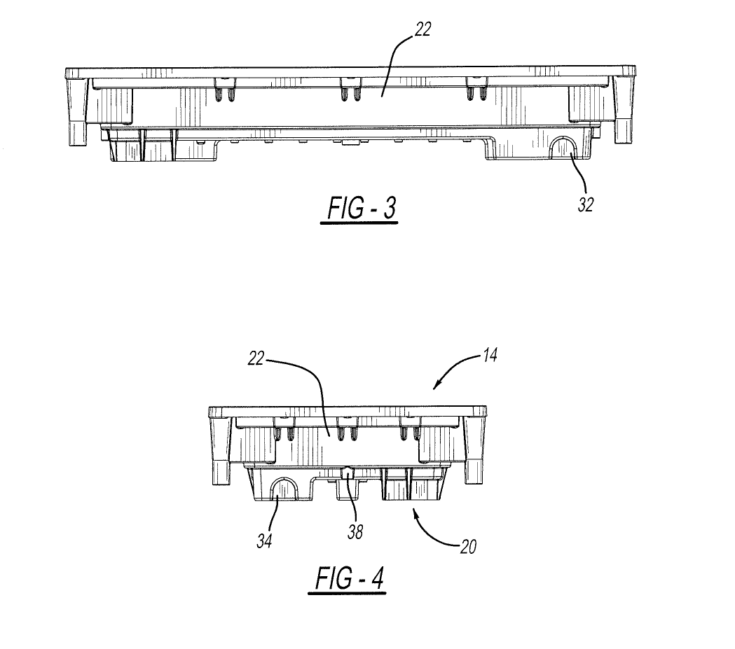

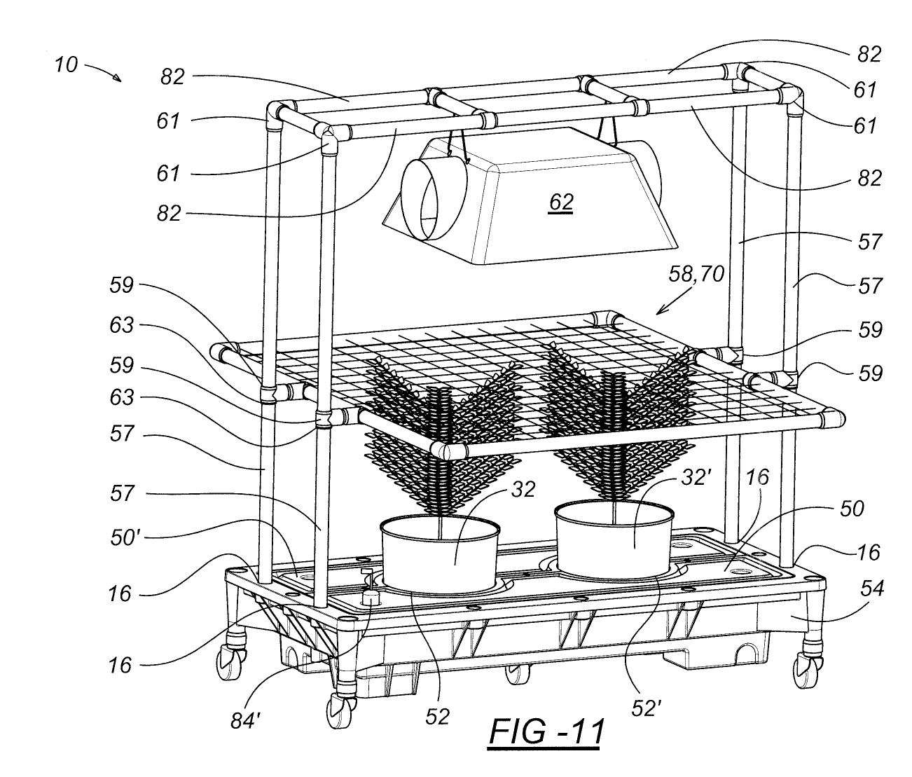

The present invention is directed to a modular flood table arrangement 10 for use in horticulture. Referring to FIGS. 1-5 a flood table 12 is shown, which is used in connection with and is the same as flood tables 54, 72, 74, 76, 110, 118, 120 in the modular flood table arrangement 10 shown in the FIGS. 11-17 that take many different forms depending on the desired design and arrangement of the various components. For ease of reference the detailed description and FIGS. 1-5 will make reference only to flood table 12 but it is understood that flood tables 54, 72, 74, 76, 110, 118, 120 are identical to flood table 12 described in FIGS. 1-5 herein. The flood table 12 has a top edge 14 with tent frame apertures 16 and table frame apertures 18, which are collectively referred to as two or more apertures 16, 18 because certain applications of the modular flood table arrangement utilize the tent frame aperture 16, the table frame apertures 18 and combinations of the two.

The top edge 14 forms an opening where a bottom surface 20 is located. One or more side walls 22 extend between the top edge 14 and terminate at the bottom surface 20. The one or more side walls 22 give the flood table 12 a container depth that allows planting containers or growing medium to be placed within the flood table 12. In the embodiment shown in FIGS. 1-5 there is a total of four side walls 22, it is within the scope of this invention for there to be a greater or lesser number of walls depending on the shape of the flood table 12. For example is the flood table 12 is triangular in shape there would be three side walls, while a flood table that is circular in shape would have a single rounded side wall.

Another optional feature show in FIGS. 1-5 is that the bottom surface 20 has a smaller area than the top edge 14 resulting in the side walls 22 being angled from the top edge 14 to the bottom surface 20. This allows for multiple flood tables to nest within each other when they are to be stored.

The bottom surface 20 has a flood channel 24 defined by dividers 26 that water flows into during filling of the flood table 12. The flood channel 24 allows water and nutrients to flow under planters since the planters will rest on the dividers 26 and not directly of the bottom surface 20. This assists in allowing water to flow around a container 32, 32′ (shown in FIG. 11) and permit liquid to flow through the flood table 12 even when the containers 32, 32′ are placed in the flood table 12. In some arrangements plants growing in soil or solid medium are placed on the tops of the dividers 26 without being in containers, which will directly expose the roots of the plant to the liquid in the flood channel 24. The dividers 26 also are used to hold air stones and nutrient pellets.

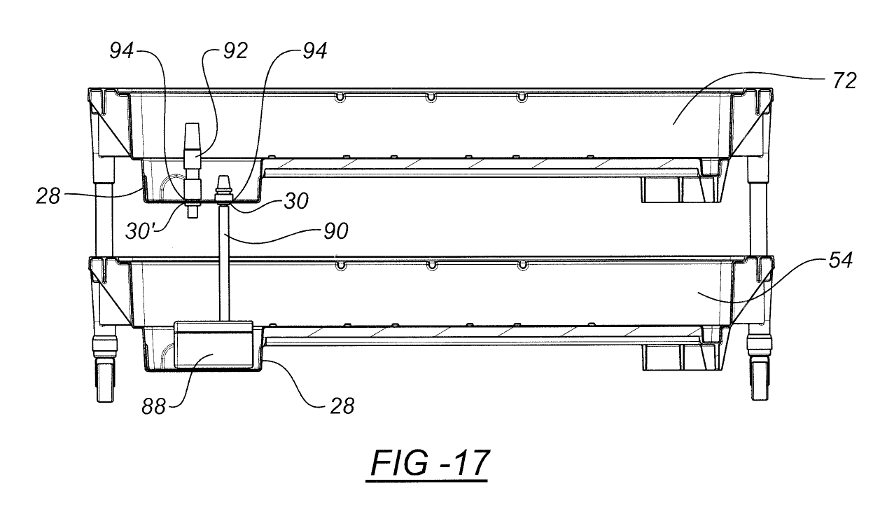

The two corners of the bottom surface 20 have two or more drain wells 28 that serve many different purposes depending on the type of modular flood table arrangement setup that the flood table 12 is to be used for. While two drain wells 28 are shown it is within the scope of this invention for additional wells to be formed anywhere on the bottom surface 20. The drain wells 28 have depressions or starter holes that serve as locators for an inlet 30 and outlet 30′, which a user of the flood table 12 will drill a hole and connect a grommet 94 (shown in FIG. 17) and tube that is used for adding and draining water from the flood table 12. The use of the starter holes for the inlet and outlet 30, 30 is helpful when there are multiple flood tables arranged vertically and it is desirable to transport liquid media from a bottom flood table up to other flood tables located vertically above the bottom table.

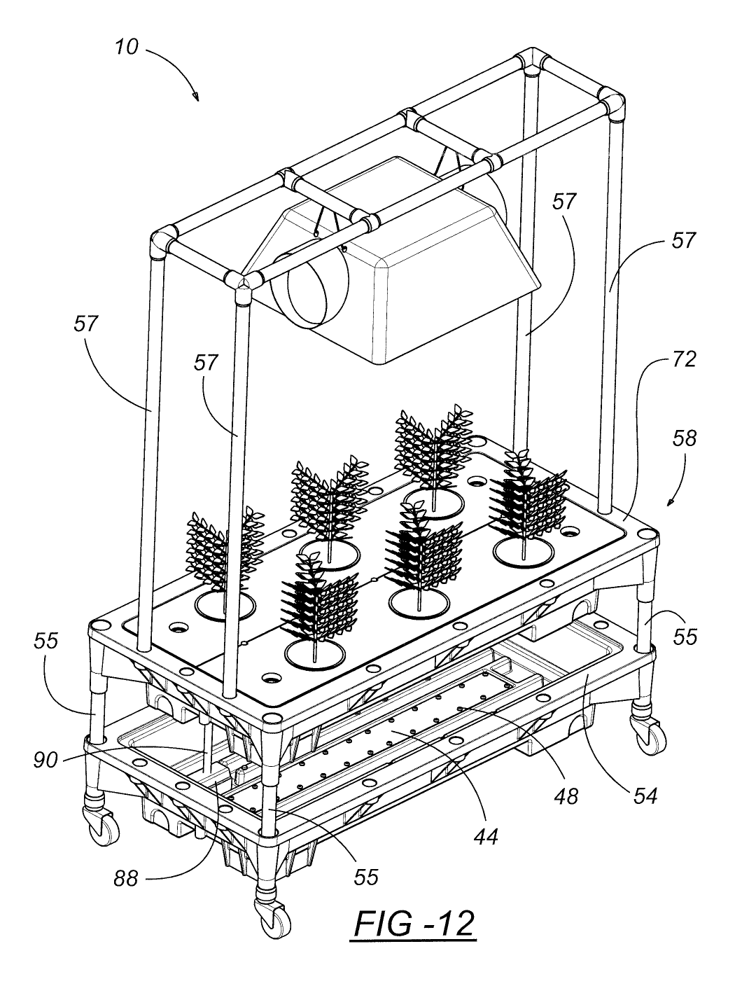

FIGS. 12 and 17 show a first row flood table 54 and a second row flood table 72. In particular FIG. 17 shows a cross-sectional view of the first row flood table 54 and second row flood table 72. There is a pump 88 located within one of the drain wells 28 in the first row flood table 54. Liquid medium from the first row flood table 54 is pumped vertically upward to the second row flood table 72 using the pump 88, which moves the liquid medium vertically through a supply tube 90 that is connected to the inlet 30 of the second row flood table 72, located in one drain well 28 located in the second row flood table 72. There is also an overflow valve 92 connected to the outlet 30′ in the drain well 28 of the second row flood table 72. When liquid within the second row flood table 72 reaches a predetermined level, defined by the height of the drain valve 92, liquid will pass through the top of the drain valve 92 and exit the outlet 30′ where the liquid will drop vertically back into the first row flood table 54.

The use of the pump 88, supply tube 90 and overflow valve 92 can be repeated for additional rows. For example if 3 or 4 rows of flood tables are present than the pump 88 located in the first row flood table 54 can be configured to pump liquid media vertically up to the top row and each of the tables located above the first row flood table 54 will have an overflow valve 92 that will cause the liquid media to drop vertically between the rows when the liquid levels gets too high.

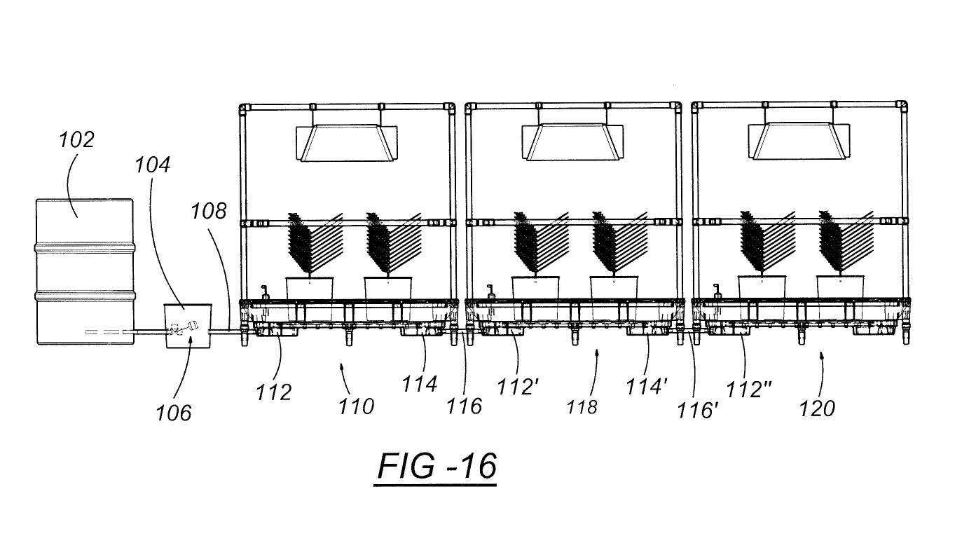

Referring back to FIGS. 1-5 the drain wells 28 also have a vertical inlet-outlet locator 31, 31′ that are formed on the side of the drain well 28. The vertical inlet locator 31 and the vertical outlet locator 31′ are used in the modular flood table arrangement 10 where it is desirable to have an inlet and outlet of the drain well 28 located on a side perpendicular to the bottom of the drain well 28. FIG. 16 shows a horizontal modular flood table arrangement 100 where several flood tables are connected together in series horizontally using the vertical inlet-outlet locator 31, 31′ between each of the flood tables. In particular FIG. 16 shows a liquid supply tank 102 that is filled with liquid medium, such as water or some type of nutrient liquids. The liquid supply tank 102 is connected to a valve box 104 that contains a flotation valve 106 that automatically opens and closes depending on the height of the liquid in the flood tables.

A liquid supply tube 108 is connected between the valve box 104 and a first row flood table 110 at a first drain well 112. A second drain well 114 of the first flood table 110 has an outlet for the first flood table 110 by having a connection tube 116 that passes liquid medium through the connection tube 116 onto a second flood table 118. The second flood table 118 receives liquid medium from the connection tube 116 through an inlet formed through a first drain well 112′ which fills the second flood table 118 with liquid. The liquid in the second flood table 118 leaves through a second drain well 114′ using a connection tube 116′ that passes the liquid medium from the second flood table 118 to a third flood table 120. The liquid medium from the connection tube 116′ enters through an inlet formed in a first drain well 112″.

The arrangement 100 is configured so that if the liquid level in any one of the flood tables 110, 118, 120 becomes low, liquid from an adjacent flood table will flow into the table in order to keep the supply of liquid at a desired level. A low level of liquid in one of the flood tables 110, 118, 120 will be transferred back to the flood table 110, which will have a low liquid level that will be transferred back to the valve box 104, which in turn causes the flotation valve 106 to open allowing liquid media from the supply tank 102 to flow through the valve box 104 and onto the flood tables 110, 118, 120. The horizontal modular flood table arrangement shown in FIG. 16 eliminates the need to manually monitor liquid levels of each individual flood table since the use of the valve box 104 and supply tank 102 will automatically keep the flood tables full of liquid. A user of the arrangement will only need to monitor the supply tank 102 to ensure that there is an adequate amount of liquid located in the supply tank 102.

The horizontal arrangement 100 shows three flood tables 110, 118, 120, however, it is possible to have additional flood tables added. Also the arrangement 100 is shown as having the flood tables 110, 118, 120 arranged in a straight line, it is possible for them to be arranged side by side (i.e., Perpendicular to the page of FIG. 16) so that the tables could re-circulate liquid medium back to the supply tank 102. A side-by-side arrangement can be accomplished using the vertical inlet-outlet locator 31, 31′ which are located on perpendicular sides of the drain well 28, 112, 112′, 112″.

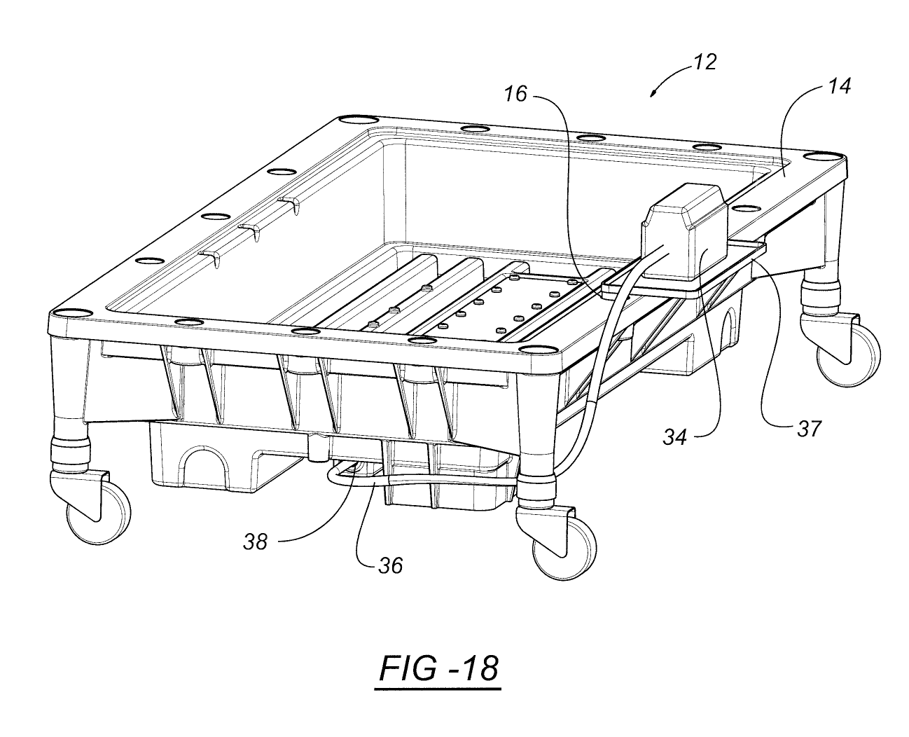

Referring to the FIGS. 1-5 and 18 the bottom surface 20 of the flood table 12 also has an aeration channel 40 that is a longitudinal channel having an aeration inlet 38 that receives a hose 36 though the aeration inlet 38, which is connected to a gas source, which is an air pump 34 that is connected to the flood table 12 using a pump holder 37 that has pegs that slide into two of the tent frame apertures 16 to secure the pump holder 37 to the edge 14 of the flood table 12. While an air pump 34 is shown, it is within the scope of this invention for the air pump 34 to be substituted with some other gas source, such as a compressed gas canister having a desired gas mixture. Accordingly the pump 34 can be substituted with a gas canister and a controllable valve. The gas source may be any suitable gas that helps to promote plant growth, including oxygen, nitrogen, ammonia, carbon dioxide and combinations thereof. The gas also helps to aerate the liquid or water in the flood channel 24 with a desired gas, which helps to promote plant growth.

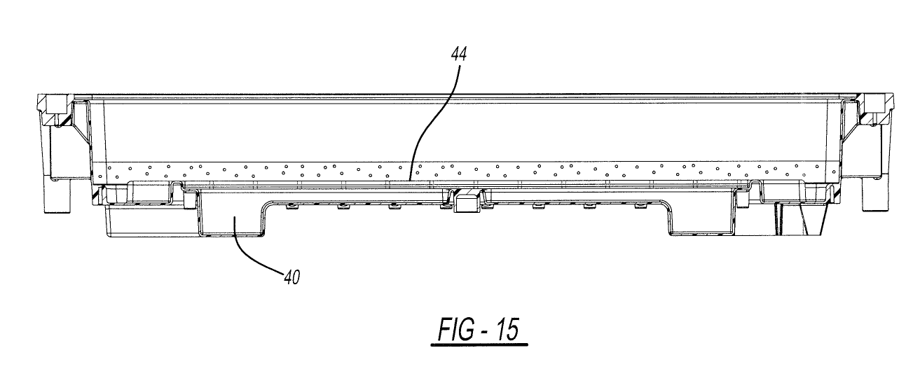

Referring additionally to FIG. 15, the aeration channel 40 has a lip 42 (shown in FIG. 2) that is used to connect an aeration plate 44. Standard fasteners, such as screws or pens are used to lock the aeration plate 44 to the lip 42. It is also possible to use adhesives or some other suitable connection. The aeration plate 44 is a polyvinyl chloride plate with pores 46 that allow the gas in the aeration channel 42 pass through the pores 46, but the pores 46 are impermeable to liquid passing through the pores 46. As shown in FIG. 15 the gas within the aeration channel 40 passes through the pores 46 of the aeration plate 44 and bubbles into the liquid located above the aeration plate 44. Any liquid contained within the flood channel 24 will not penetrate through the pores 46 of the aeration plate 44. The aeration plate 44 is secured to the lip 42 using fasteners 48. Optionally there may be a rubber seal or grommet disposed between the aeration plate 44 in the lip 42 which ensures a tight seal between the aeration plate 44 and the lip 42. While the present embodiment of the invention includes an aeration plate 44 that is made of polyvinyl chloride, it is within the scope of this invention for the aeration plate 44 to be formed of other suitable porous materials provided they allow the passage of gas or air bubbles, but do not allow more dense liquids to pass through the pores.

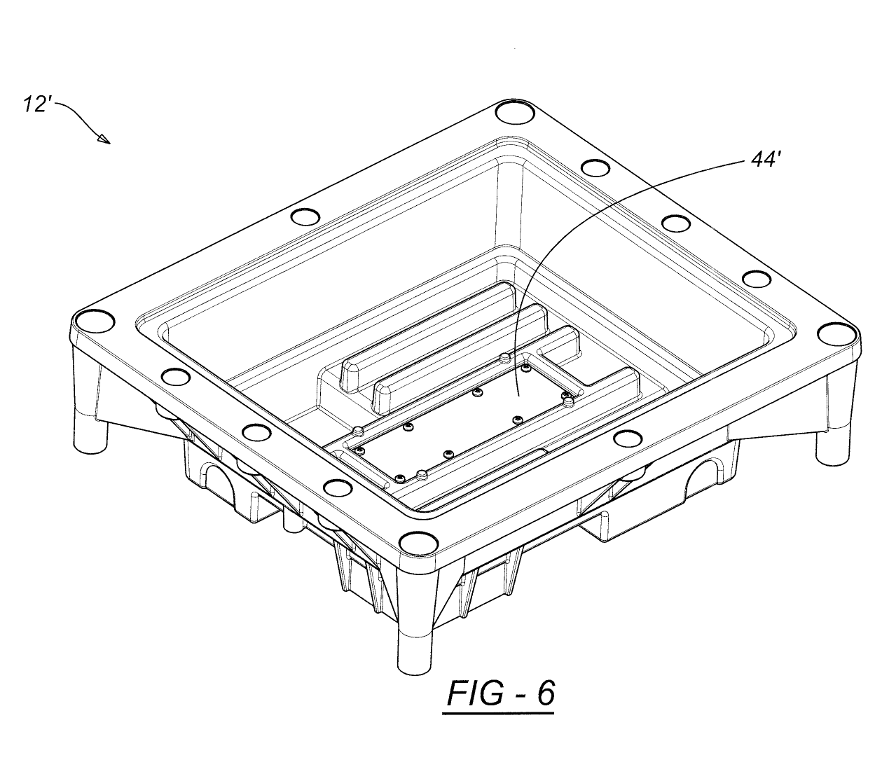

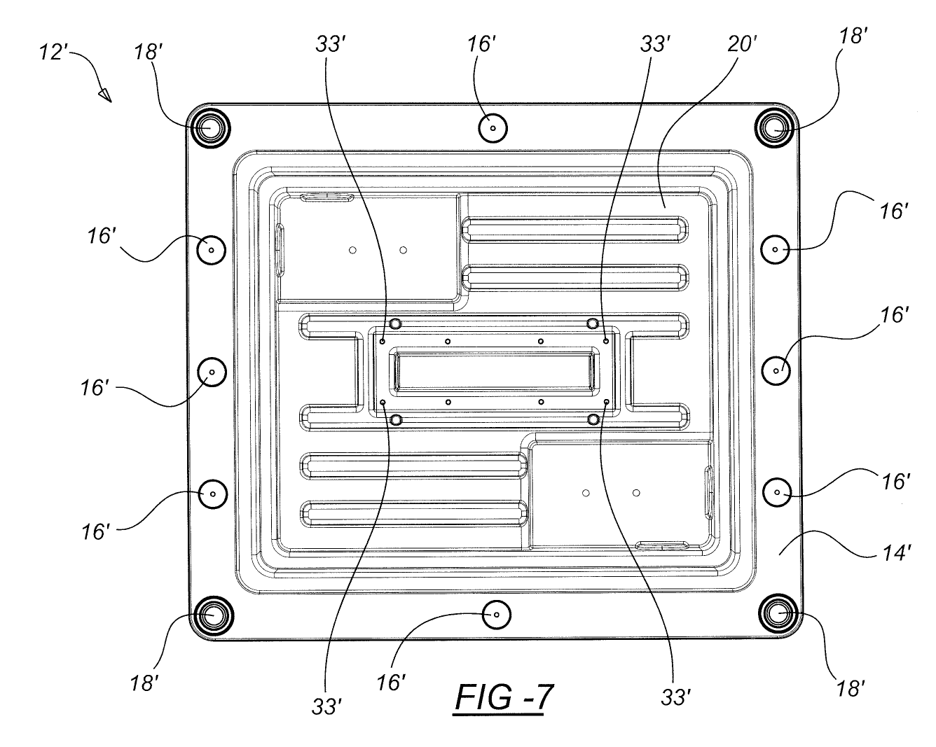

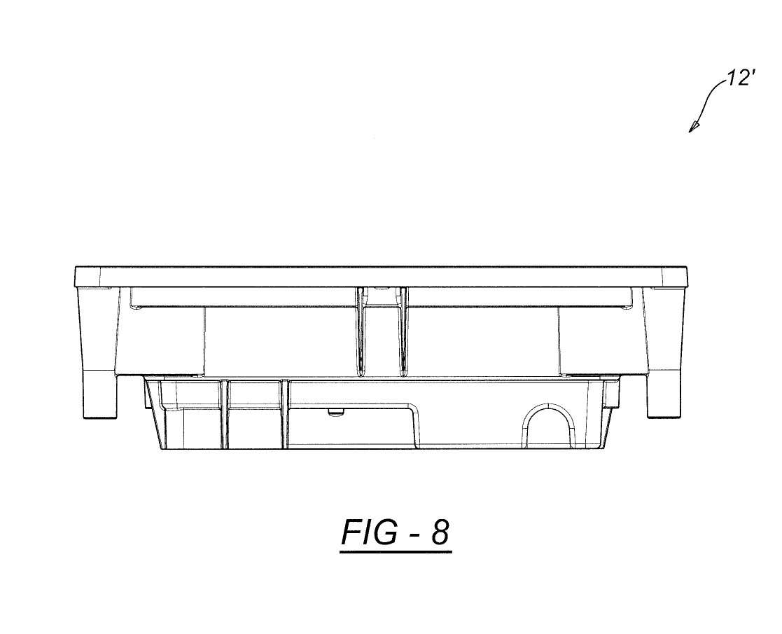

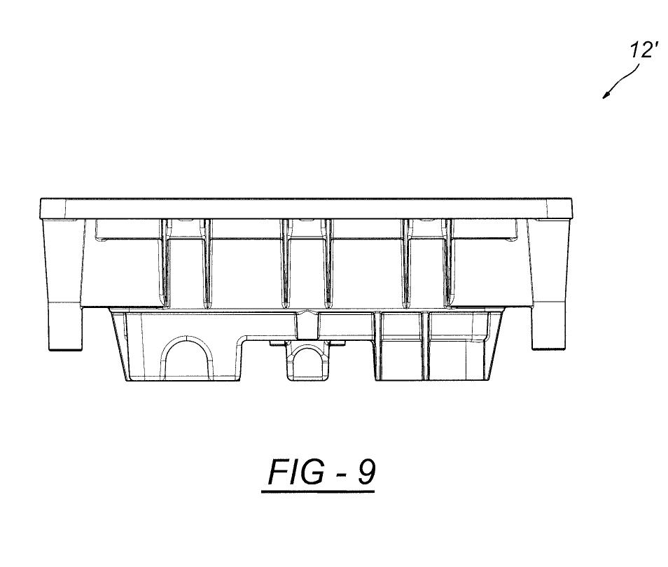

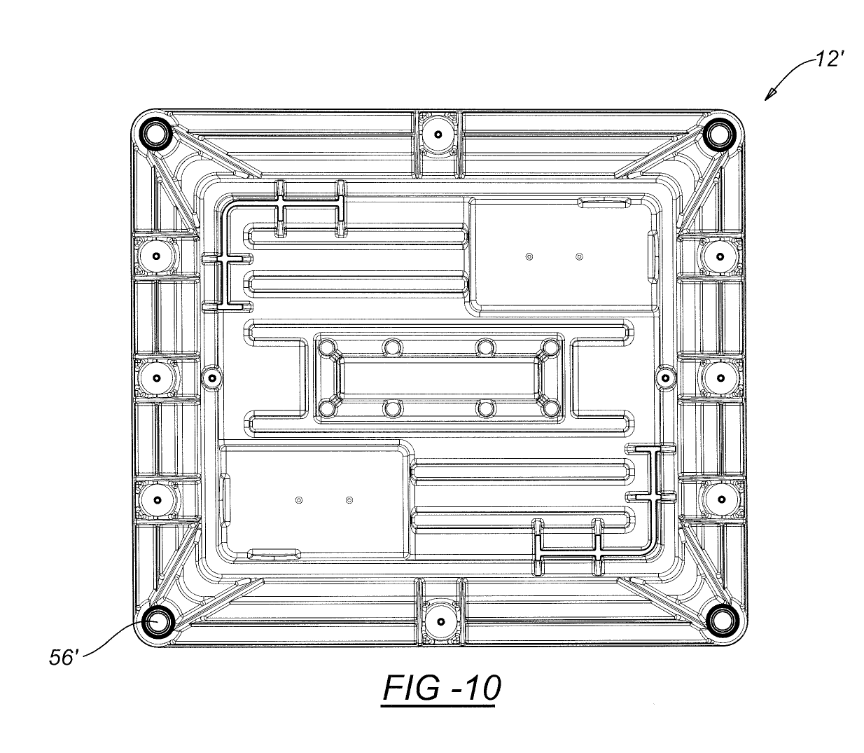

Referring now to the flood table 12 of FIGS. 1-5 and an alternately sized flood table 12′ in FIGS. 6-10 is shown. Similar structures in FIGS. 6-10 will be designated with the same number as the structure in FIGS. 1-5 except they will be a prime number in FIGS. 6-10. The bottom surface 20,20′ of the flood table 12 has eight planter locator tabs 33 and the bottom surface 20′ of the flood table 12′ has four planter locator tabs 33′. The locator tabs location and number depend on the type of container that the flood table 12, 12′ is designed to be used with. Thus a greater or lesser number of locators and different locations of the locator tabs 33, 33′ are used depending on the types of planters the flood table is used with. The use of the locator tabs 33, 33′ helps to position the planter directly over the aeration plate 44, 44′ so that there is optimum contact between the gasses released from the aeration plate 44, 44′ and the plant roots.

The locator tabs 33, 33′ also position planter containers so that covers can be placed on any of the flood tables described in this application. In particular FIG. 11 shows planter containers 32, 32′ placed within a flood table 54, in the flood table arrangement 10. The locator tabs 33, shown in FIGS. 1-5 properly position the planter containers 32, 32′ in their proper locations so that one or more covers 50, 50′ having one or more openings 52, 52′ configured to surround the planter containers 32, 32′. The one or more covers 50, 50′ also extend across the opening 15 of the flood table 54. The covers are sized so that they circumscribed a properly sized and properly located planter containers 32, 32′. The covers 50, 50′ prevent evaporation, spilling and release of gas from the inside of the flood table 54.

The present embodiment of the invention shows to cover members 50, 50′ creating two halves that extend across the opening 15 of the flood table 54, however it is within the scope of this invention for a greater or lesser number of cover members to be used. For example in the embodiment shown 6-10 there is shown a flood table 12′ (as discussed in greater detail below) that holds a single container, therefore it would not be necessary to have a cover member that is multiple pieces.

Referring now to FIGS. 6-10 a second alternate embodiment showing the flood table 12′ is shown. The flood table 12′ differs from the flood table 12 in that the dimensions of the flood table 12 are larger than the dimensions of the flood table 12′. More specifically the flood table 12 has an overall length of about 4 feet, a width of about 2 feet and a height or depth of about 1 foot. The flood table 12′ has an overall length of about 2 feet, a width of about 2 feet and a depth of about 1 foot. Another difference is that the flood table 12′ has a bottom surface 20′ with planter locator tabs that are positioned on the bottom surface 20′ in different dimensions than the flood table 12. The reason for this is that the planter locator tabs for flood table 12′ are designed for locating a single planter within the flood table 12′ that is different in dimension. The dimensions of the container that is intended to be positioned within the flood table 12′ is a round container having a diameter of about 10 inches to about 10.5 inches in diameter measured at the base of the container. Generally speaking containers are larger at the top than at the base. While specific dimensions are given for the diameter of the containers and the dimensions of the flood tables, it is within the scope of this invention for both flood tables 12, 12′ and the containers to be of any size. Generally the containers used are round containers, however it is possible for them to have other shapes such as squares, triangles, rectangles, etc.

The flood table 12′ shown in the second embodiment of the invention, also has a different number of tent frame apertures 16′ which is due to the fact that a top edge 14′ of the flood table 12′ is not as large as the top edge 14 of the flood table 12. The smaller size of the flood table 12′ reduces the number of frame members needed to form various modular flood table arrangement 10 combinations using the flood table 12′. The flood table 12′ has four table frame apertures 18′ and the bottom surface of the flood table 12′ has four bottom frame apertures 56′. The bottom frame apertures 56′ in the table frame apertures 18′ allow for vertically connecting multiple flood tables 12′ and providing four points of support.

Referring now to FIGS. 11-18 various features and growing arrangements of the modular flood table arrangement 10 are shown and described. The modular flood table arrangement 10 shown in FIGS. 11-15 and 16-18 has a first row flood table 54 shown, which is identical to the flood table 12 describe in FIGS. 1-5 above. It is also possible to use the flood table 12′ instead of the flood table 12 in the first embodiment.

The modular flood table arrangement 10 includes two or more vertical frame members 57 each being connected to one of the two or more apertures 16,18 located on the top edge 14 of the first row flood table 54. Connected to the two or more vertical frame members 57 is one or more additional accessories 58. Additional accessories 58 include a tent 60 over the first row flood table, lights 62, 64, 66, 68, a scrog 70 and additional rows of flood tables 72, 74, 76.

Referring now to FIG. 11 a flower assembly of the modular flood table arrangement 10 is shown. The flower assembly is typically used to grow mature plants. The first row flood table assembly 54 contains two planter containers 32, 32′ surrounded by the covers 50, 50′ which have openings 52, 52′ that receive or surround the planter container 32, 32′. The plants grow vertically upward from the planter containers 32, 32′ and are connected to the additional accessories 58, which in this particular embodiment of the invention is the scrog 70. The scrog 70 is a horizontal grid or net that is used to grasp and hold the plant upright as it grows vertically. The scrog 70 connects between the two or more vertical members 57, which are connected to tent frame apertures 16 of the first row flood table 54. Located above the scrog 70 are two horizontal frame members 82 that connect between the two or more vertical frame members 57. A light 62 is connected to the two horizontal frame members 82 and is configured to shine light vertically downward onto the plants growing in the containers 32, 32′. Flood table 54 is filled with the liquid, such as water and nutrients that help the plants grow. The liquid level within the first row flood table 54 is monitored using a floating liquid level indicator 84″, which is essentially a float with a flag that extends through one of the covers 50, 50′ so that the liquid level can be determined without removing the covers 50, 50′.

As shown in FIG. 12 the two or more table frame members 55 connect to the bottom of a second row flood table 72 using bottom frame apertures 56 that are formed on the bottom of the second row flood table 72 and table frame apertures 56 on the first row flood table 54. The bottom frame apertures 56 are a common feature located on the flood table 12, first row flood table 54 and additional rows of flood tables 72, 74, 76. FIG. 12 shows what is commonly referred to as a vegetative or veg assembly where the second row flood table 72 has maturing plants and the first row flood table 54 can optionally be used to grow or cultivate less mature plants (not shown). In FIG. 12 the growing plants have been removed from the first row flood table 54 so that the aeration plate 44 and fasteners 48 are more clearly seen.

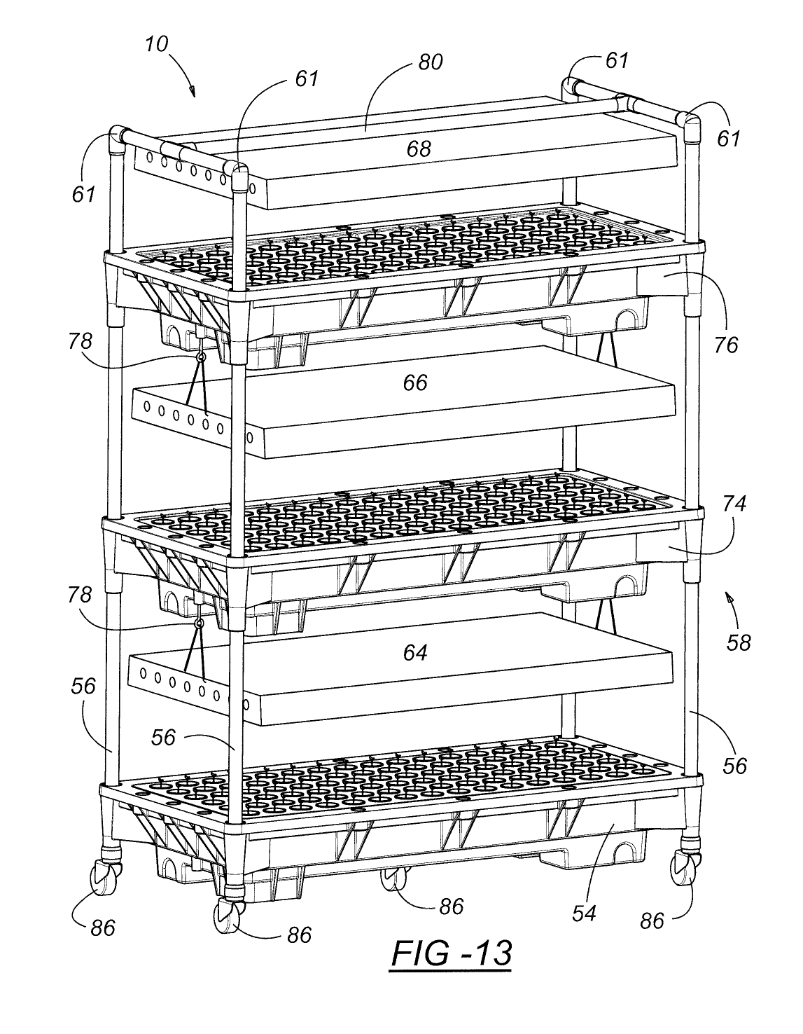

FIG. 13 depicts a modular flood table arrangement 10 that is commonly referred to as a clone assembly. This particular embodiment contains a first row flood table 54, second row flood table 74, and third row flood table 76. Each of the flood tables contain several miniature clones growing within the flood table. Located above the first row flood table 54 is a light 64 connected to the bottom of the second row flood table 74 using in eyelet 78. A light 66 is connected to the bottom of the third row flood table 76 using an eyelet 78′. Above the third row flood table 76 is a light 68 that is connected to a single horizontal frame member 80 that extends between the two or more vertical frame members 57 and is connected using end joints 61. The clone assembly depicted in FIG. 13 allows each of the rows of flood tables to have their own individual lights that provide direct light to the respective flood tables. This eliminates the need to have reflectors or other mechanisms for directing light between the rows.

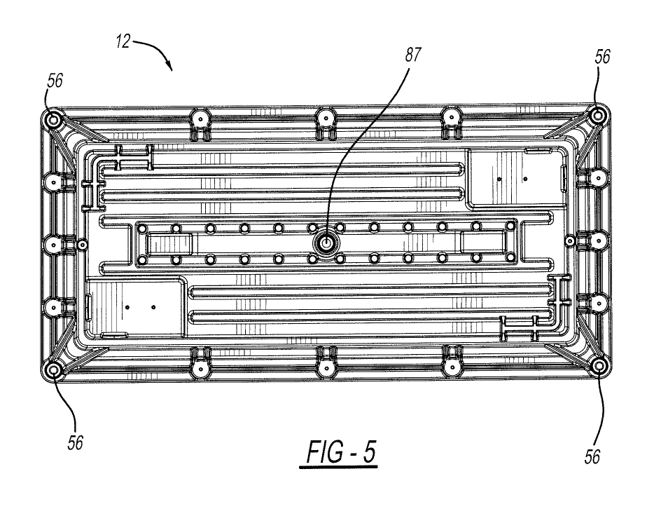

The modular flood table arrangement 10 in any of the figures of the invention is very heavy, particularly when filled with liquid. It is desirable to be able to move the modular flood table arrangement 10 without having to drain the liquid. Therefore in the embodiment shown in FIGS. 11-13 the first row flood table 54 has casters 86 that are used to move the modular flood table arrangement 10. The casters 86 are configured to connect to the bottom frame apertures 56 formed on the bottom of the first row flood table 54 with an additional caster being located within an aperture 87 (shown best in FIG. 5) in the center of the bottom outside surface of the first row flood table 54. As shown there is a total of five casters, However it is within the scope of this invention for a greater or lesser number of casters to be used depending on the needs of a particular application.

While FIGS. 1-5 and 18 depict the flood table 12, the other drawings show flood tables 54, 72, 76, 110, 118, 120 that are identical to flood table 12. Therefore the use of any of the accessories described above can be used in connection with the various flood tables shown. Additionally flood table 12′ can also be used with the various accessories described in this invention, with the main difference being that flood table 12′ has a different size, therefore there are not as many tent frame apertures 16′ available as there are with the other flood tables described above.

The table frame members 55 and vertical frame members 57 are single piece poles or they may be multiple tube segments that can be connected together. At the end of the vertical frame members 57 are end joints 61 that are used to connect the horizontal frame members 82. There are also lockable collars 59 that are used to attach the additional accessories 58 such as the scrog 70. The lockable collars 59 are vertically locked to a desired height on the vertical frame member 57 using an o-ring 63 that creates a lockable wedge fit between the table frame member 55 or vertical frame member 57 and the lockable collar 59 in order to lock the lockable collar 59 at specific locations.

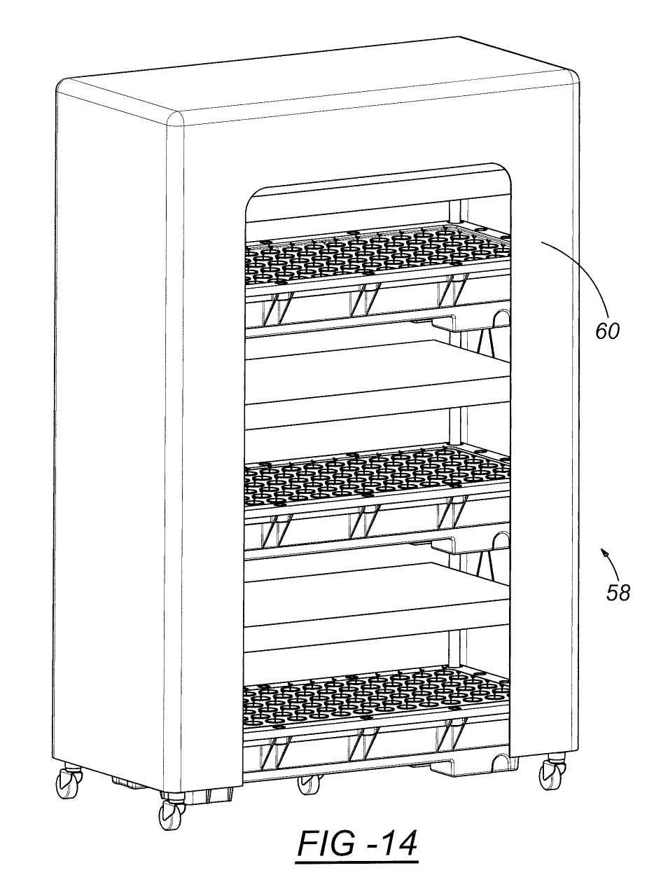

Referring now to FIG. 14 another feature of the flood table arrangement 10 shows the flood table arrangement enclosed by the tent 60. Tent 60 is used to control humidity and air quality for optimum growing of the plant within the flood table. The tent 60 can be formed of hard walls or it may be a soft enclosure made of vinyl, fabric or some other polymer type material. The tent 60 is configured to drape or wrap around the entire modular flood table arrangement 10 can be supported by the vertical frame members 57 and table frame members 55.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A modular flood table arrangement comprising:
a first row flood table including a top edge having two or more apertures, a bottom surface; one or more walls extending between the top edge and the bottom surface, wherein the top edge forms an opening of the first row flood table;
two or more drain wells formed on the bottom surface;
an inlet and an outlet formed on the bottom surface and located in a respective one or the two or more drain wells;
a flood channel formed on the bottom surface for holding a liquid, said flood channel directs the liquid between the two or more drain wells, between the inlet and the outlet;
an aeration channel formed in the bottom surface below the flood channel;
an aeration plate extending over the aeration channel;
an aeration inlet located in the aeration channel and extending through the bottom surface to an exterior surface of the first row flood table, said aeration inlet being connected to a gas source that pumps gas into the aeration channel, said gas migrates through the aeration plate into liquid in the flood channel located above the aeration plate;
two or more vertical frame members, wherein each individual one of said two or more vertical frame members are connected to a respective one of said two or more apertures; and
one or more additional accessories connected to the two or more vertical frame members.

2. The modular flood table arrangement of claim 1 wherein said two or more apertures are tent frame apertures that each receive one of the two or more vertical frame members and the two or more vertical frame members are used to connect a tent over the first row flood table, thereby creating an enclosed growing area.

3. The modular flood table arrangement of claim 2 further comprising:
one or more horizontal frame members connecting together two or more vertical frame members;
one or more lighting units connected to the one or more horizontal frame members above the flood table so that the one or more lighting units selectively shine light onto the first row table one table, said one or more lighting units are figured to shine light onto first row flood table.

4. The modular flood table arrangement of claim 1 wherein said two or more apertures are tent frame apertures that each receive one of the two or more vertical frame members and the two or more vertical frame members are used to connect a scrog over the first row flood table.

5. The modular flood table arrangement of claim 4 further comprising:
one or more horizontal frame members connecting together two or more vertical frame members, said one or more horizontal frame members being located above said scrog;
one or more lighting units connected to the one or more horizontal frame members above the scrog and the flood table so that the one or more lighting units selectively shine light onto the first row table one table.

6. The modular flood table arrangement of claim 1 wherein said two or more apertures are table frame apertures that each receive one of the two or more vertical frame members and the two or more vertical frame members are used to connect to a second row flood table that will be located above the first row flood table, wherein the second row flood table is identical to the first row flood table.

7. The modular flood table arrangement of claim 6 further comprising:
wherein said two or more apertures of said second row flood table include tent frame apertures that each receive one of the two or more vertical frame members and the two or more vertical frame members are used to connect a scrog over the second row flood table;
one or more horizontal frame members connecting together two or more vertical frame members, said one or more horizontal frame members being located above said scrog;
one or more lighting units connected to the one or more horizontal frame members above the scrog and the flood table so that the one or more lighting units selectively shine light onto the second row table one table.

8. The modular flood table arrangement of claim 7 further comprising one or more lighting units connected to the bottom side of the second flood table so that the one or more lighting units connected to the bottom side of the second flood table selectively shine light onto the first row flood table.

9. The modular flood table arrangement of claim 6 further comprising one or more lighting units connected to the bottom side of the second flood table so that the one or more lighting units connected to the bottom side of the second flood table selectively shine light onto the first row flood table.

10. The modular flood table arrangement of claim 6 further comprising:
two or more apertures on the second row flood table that are table frame apertures that each receive one of the two or more vertical frame members and the two or more vertical frame members are used to connect to a third row flood table that will be located above the second row flood table, wherein the third row flood table is identical to the first row flood table.

11. The modular flood table arrangement of claim 10 further comprising:
two or more apertures of said third row flood table that are tent frame apertures that each receive one of the two or more vertical frame members;
one or more horizontal frame members connecting together two or more vertical frame members connected to the third row flood table, said one or more horizontal frame members being located above said third row flood table;
one or more lighting units connected to the one or more horizontal frame members above the third row flood table so that the one or more lighting units selectively shine light onto the third row flood table;
one or more lighting units connected to the bottom side of the third row flood table so that the one or more lighting units connected to the bottom side of the third row flood table selectively shine light onto the second row flood table; and
one or more lighting units connected to the bottom side of the second row flood table so that the one or more lighting units connected to the bottom side of the second row flood table selectively shine light onto the first row flood table.

12. The modular flood table arrangement of claim 1 wherein the aeration plate is a polyvinyl chloride plate with pores that allow gas to pass through the pores and the pores are impermeable to liquid passing through the pores.

13. The modular flood table arrangement of claim 1 wherein the one or more additional accessories includes one or more of the group comprising:
an additional flood table, a scrog, lights, netting, a soft enclosure, a hard enclosure, tubing or combinations thereof.

14. The modular flood table arrangement of claim 1 further comprising a pump contained in one of the one or more drain wells for pumping liquid from the inlet into the flood channel.

15. The modular flood table arrangement of claim 1 wherein the liquid in the flood channel drains through the outlet of the first row flood table.

16. The modular flood table arrangement of claim 1 wherein the outlet of the first row flood table is blocked to prevent liquid from leaving the first row flood table.

17. The modular flood table arrangement of claim 1 further comprising:
two or more locator tabs formed on the bottom surface;
one or more planters configured to be placed on the bottom surface and aligned using the two or more locator tabs; and
one or more covers having one or more openings configured to surround the one or more planters, said one or more covers extend across the opening of the first row flood table.

18. A modular flood table arrangement comprising:
one or more flood tables, each having:
a top edge having two or more tent frame apertures and two or more table frame apertures;
a bottom surface;
one or more walls extending between the top edge and the bottom surface, wherein the top edge forms an opening that is larger than the bottom surface and the one or more side walls are angled between the top edge and the bottom surface for allowing more than one flood table to nest within each other;
one or more drains formed on the bottom surface;
one or more inlets formed on the bottom surface;
one or more drain wells formed on the bottom surface;
a flood channel formed on the bottom surface for directing liquid between the inlet and the outlet;
an aeration plate receiving portion formed on the bottom surface;
an aeration channel formed in the bottom surface below the aeration plate and the flood channel;
two or more table frame members, wherein said table frame members are received through one of said two or more table frame apertures;
two or more vertical frame members, each having an end connected to one of the two or more tent frame apertures for receiving a vertical frame member extending above the top edge of one of the one or more flood tables; and
one or more additional accessories connected to the two or more vertical frame members.

19. The modular flood table arrangement of claim 18 wherein the aeration plate is a polyvinyl chloride plate with pores that allow gas to pass through the pores and the pores are impermeable to liquid passing through the pores.

20. The modular flood table arrangement of claim 18 wherein the one or more additional accessories includes one or more of the group comprising:
an additional flood table, a scrog, lights, netting, a soft enclosure, a hard enclosure, tubing or combinations thereof.
